(19) United States
(12) Patent Application Publication
(10) Pub. No.: US 2026/0099128 A1
(43) Pub. Date: Apr. 9, 2026

(54) CONTROLLING INDUSTRIAL FACILITIES USING HIERARCHICAL REINFORCEMENT LEARNING

(71) Applicant: DeepMind Technologies Limited, London (GB)

(72) Inventors: William Wong, Cupertino, CA (US); Praneet Dutta, Sunnyvale, CA (US); Jerry Jiayu Luo, San Mateo, CA (US)

(21) Appl. No.: 19/111,967

(22) PCT Filed: Sep. 14, 2023
(86) PCT No.: PCT/EP2023/075295

§ 371 Date: Mar. 14, 2025

Related U.S. Application Data
(60) Provisional application No. 63/406,680, filed on Sep. 14, 2022.

(51) Int. Cl. F28F 27/00; G05B 13/02; G06N 3/092

(52) U.S. Cl. CPC F28F 27/003; G05B 13/027; G06N 3/092

(57) ABSTRACT

Methods, systems, and apparatus, including computer programs encoded on a computer storage medium, for controlling a facility through hierarchical reinforcement learning. In particular, the facility is controlled using a high-level controller neural network that makes high-level decisions and a low-level controller neural network that makes low-level controller decisions.

### CROSS-REFERENCE TO RELATED APPLICATION

This application claims priority to U.S. Provisional Application No. 63/406,680, filed on Sep. 14, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an industrial facility.

In particular, the system controls the industrial facility using a hierarchical scheme, i.e., using a high-level controller neural network and a low-level controller neural network.

The system can generally be used to control aspects of equipment in a variety of types of industrial facilities.

For example, the high-level controller neural network can be used to determine whether to change the operational state of each of one or more items of equipment within the industrial facility and the low-level controller neural network can be used to set a value of an operating property for each item of equipment that is to be enabled according to the new operational states.

In some implementations, the industrial facility is a facility that has a chiller plant that includes multiple chillers and the system controls the chillers within the chiller plant.

Particular embodiments of the subject matter described in this specification can be implemented so as to realize one or more of the following advantages.

Reinforcement learning (RL) techniques have been developed to optimize facilities, e.g., industrial cooling systems, offering substantial energy or other savings compared to traditional heuristic policies.

However, a major challenge in industrial control involves learning behaviors that are feasible in the real world due to machinery constraints. For example, certain actions can only be executed every few hours while other actions can be taken more frequently. Without extensive reward engineering and experimentation, an RL agent may not learn realistic operation of machinery.

To address these issues, this specification describes a hierarchical reinforcement learning scheme for controlling a facility that employs a hierarchical controller that includes a high-level neural network and a low-level controller neural network that control different subsets of actions according to their operation time scales. The described approach can, for example, achieve energy savings over existing approaches while satisfying constraints such as operating chillers within safe bounds in a heating, ventilation, and air conditioning (HVAC) control environment for a facility.

As a particular example, traditionally, controllers for HVAC systems must be tuned for a specific environment and their performances degrade when operating conditions change. Furthermore, hand tuning a controller to minimize energy usage and keep the temperature within certain constraints can be challenging.

Instead, reinforcement learning can aid operators by acting as a supervisory controller which determines setpoints for controllers to meet. By posing energy savings and temperature constraints as an optimization problem, reinforcement learning can determine more efficient setpoints. However, applying a learned policy to a real-life system poses many challenges. For one, an agent may learn to turn HVAC equipment on and off frequently, or leave them on for extended periods of time. In the real-world, building operators avoid this behavior to limit wear and tear. For offline RL, techniques like regularized behavior value estimation can prevent an agent from generating unrealistic behavior not seen in production, but are unable to reason across both extremely long and short time horizons as is required to optimally control real-world facilities.

Instead, this specification describes how to use multiple agents, each operating at different timescales, to address this issue.

A particular example arises in the context of chiller plants, a component of HVAC systems. These plants consist of multiple chillers, mechanical devices that are responsible for removing heat from the buildings. Generally, chillers should only be turned on and off every few hours and usage should be spread equally among chillers to avoid unnecessary wear and tear. At the same time, building temperature needs to be maintained within specified bounds throughout chiller cycling.

By making use of hierarchical reinforcement learning (HRL), the described techniques can reason across different time scales, with a high-level controller making longer-term decisions, e.g., which chillers should be enabled at any given time, and a low-level controller making shorter-term decisions, e.g., the temperature setpoints for the enabled chillers at any given time.

In particular, the described approach avoids the necessity of extensive reward engineering to meet building temperature requirements and minimize chiller wear and tear.

Additionally, due to the hierarchical nature, learning in the described hierarchical scheme is sample efficient and the controllers can be learned with a limited amount of data. This makes the described scheme particularly suitable for training in computationally-expensive simulation or on real-world data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example facility control system.

FIG. 1B is a diagram of an example chiller plant.

FIG. 2 is a flow diagram of an example process for controlling a facility.

FIG. 3 shows an example of the operation of the system.

Like reference numbers and designations in the various drawings indicate like elements.

### DETAILED DESCRIPTION

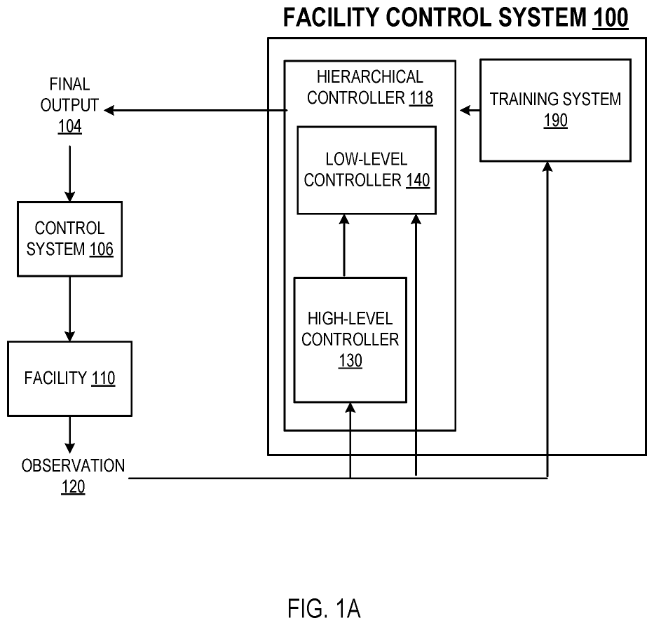

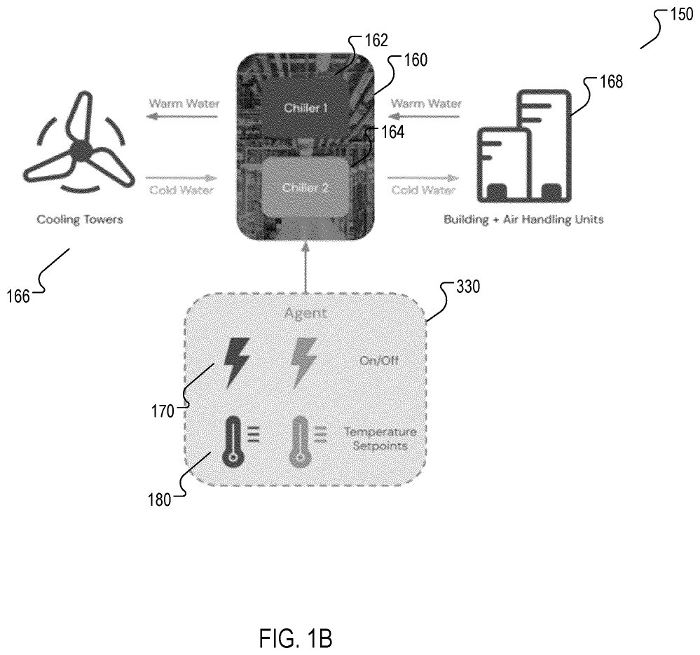

FIG. 1A shows an example facility control system 100. The facility control system 100 is an example of a system implemented as computer programs on one or more computers in one or more locations in which the systems, components, and techniques described below are implemented.

The facility control system 100 controls an industrial facility 110 by making control decisions for the industrial facility 110 at each time step in a sequence of time steps. For example, the sequence of time steps can continue indefinitely or until a termination criterion is satisfied, e.g., the facility 110 reaches a terminal state.

At each time step, the system 100 receives an input observation 120 characterizing the state of the industrial facility 110 and determines how to control the industrial facility 110 based on the observation 120 using a hierarchical controller 118.

In particular, the system 100 makes high-level control decisions using a high-level controller neural network 130 of the hierarchical controller 118 and makes low-level control decisions using a low-level neural network 140 of the hierarchical controller 118. In this context, the terms high-level and low-level are used to indicate that the decisions made using one of the controller neural networks (the low-level controller neural network 140) depend on the decisions made by the other controller neural network (the high-level controller neural network 130). That is, the output of the low-level controller network 140 at a time step is determined, at least to some extent, by the output of the high-level controller neural network 130 at the time step or at a preceding time step (e.g. a high-level output specifying whether items of equipment are to be enabled or disabled).

In particular, in some implementations, the industrial facility 110 is a facility that has a chiller plant that includes multiple chillers and the system 100 controls the chillers within the chiller plant.

FIG. 1B is a diagram 150 of an example chiller plant 160.

In the example of FIG. 1B, the chiller plant 160 has two chillers 162 and 164 that are controlled by the system 100. A chiller is a mechanical device that is responsible for removing heat from the facility 110, e.g., via a liquid refrigerant provided a set of one or more cooling towers 166.

Across time, solar radiation and facility occupants (people, computers, etc.) generate heat and warm the air in the facility 110. In order to keep the facility temperature at a specified level, the warm air is cooled by cold water provided by chillers, e.g., chillers 162 and 164. This heat exchange between cold water and warm air causes the water to heat up. The role of the chillers is to cool the warmed water down to a certain temperature specified by a control called a temperature setpoint.

Once cooled, water returns to a building 168 within the facility 110 where a control system, e.g., one or more PID controllers, use the water to meet temperature setpoints inside the building. The colder the water, the easier it is to achieve those setpoints and vice versa.

However, given that chillers are mechanical devices, chillers should only be turned on and off every few hours and usage should be spread equally among chillers to avoid unnecessary wear and tear on any given chiller. At the same time, facility temperature needs to be maintained within specified bounds throughout chiller cycling.

In order to achieve these goals, the system 100 makes use of the hierarchical controller 118 described above.

In particular, at each time step, the system 100 uses the high-level controller neural network 130 to make high-level decisions that include, for each chiller, an on-off decision 170 that determines whether to change the operational state of the chiller, i.e., whether to change the state of the chiller from enabled (“on”) to disabled (“off”) or vice versa.

The system 100 also uses the low-level controller neural network 140 to make low-level decisions that include, for each chiller that is enabled at the time step, a temperature setpoint 180 for the chiller, i.e., the temperature to which the chiller should cool the warmed water down to.

By making these high- and low-level decisions at each time step, the system 100 effectively controls the facility 110 to maintain the facility temperature within specified bounds while avoiding unnecessary wear and tear on any given chiller.

In particular, the system 100 allocates longer-term decisions, e.g., which chillers to enable and disable, to the high-level controller neural network 130 so that the high-level controller ensures that operational states of chillers are not switched too frequently. Simultaneously, the system 100 allocates short-term decisions, e.g., the temperature set points of the enabled chillers, to the low-level controller neural network 140 ensure that temperature requirements are satisfied given the current operational states of the chillers.

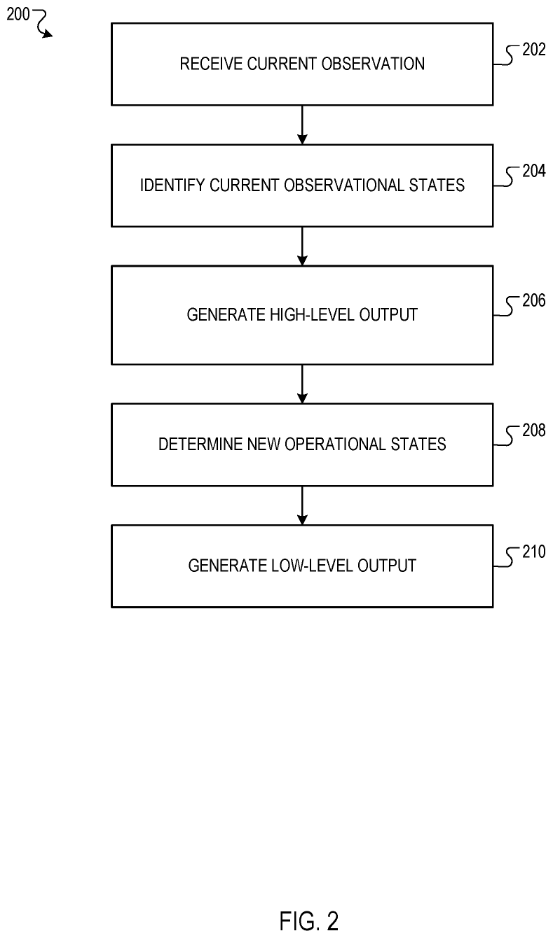

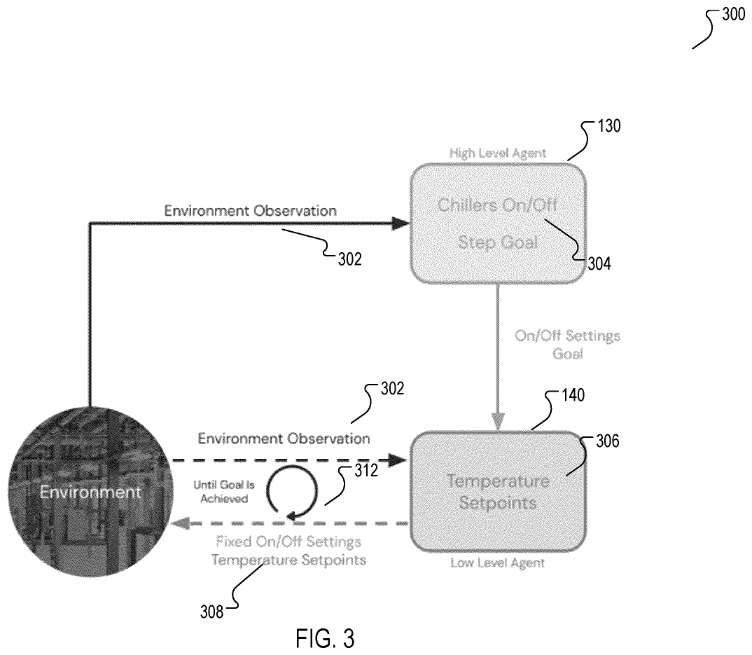

Controlling chillers will be described in more detail below with reference to FIGS. 2 and 3.

Returning to FIG. 1A, once the system 100 has generated the high- and low-level decisions, the system 100 generates a final output 104 that indicates, for each chiller, a new operational state (i.e., whether the chiller should be enabled or disabled at the time step) and, for each chiller that should be enabled, a temperature set point to which the chiller should be set at the time step.

The system 100 can use this final output 104 to control the chiller plant, i.e., to control the facility 110 by controlling the chiller plant.

For example, the system 100 can transmit data identifying the final output 104, i.e., to a control system 106 for the facility 110 that causes the plurality of chillers to operate in accordance with the new operational states and temperature set points specified by the final output 104.

The control system 106 can be, e.g., a hardware controller located within the chiller plant of the facility 110. For example, the hardware controller can be one or more PID controllers for the chiller plant.

As one example, the control system 106 can automatically modify the new operational states and set points to match those in the final output 104.

As another example, for each chiller, the control system 106 can check whether the new operational state, the temperature set point, or both violates any operational constraints for the chiller plant.

For example, the control system 106 can check whether any of the chillers that are requested to be enabled are malfunctioning or are subject to any other infrastructure failures.

As another example, the control system 106 can check whether any of the set points violate any constraints for maximum or minimum set points or any constraints on a rate of change of temperature set points for a given chiller.

If a new operational state, a temperature set point, or both, for a given chiller violate an operational constraint, the control system 106 can determine not to modify the current settings for the given chiller or can control the given chiller using a different, default control system.

Thus, in these implementations, the current operational states and set points identified at the beginning of each time step may not match those specified by the final output 104 at the preceding time step if, e.g., the control system 106 determined not to adopt a portion of the final output 104.

In order to optimize the performance of the hierarchical controller 118 in controlling the facility 110, a training system 190 within the system 100 trains the high and low-level controller neural networks 130 and 140 through reinforcement learning.

In some implementations, the system 190 trains the neural networks on data generated while the neural networks are controlling the facility 110. In some other implementations, the system 190 trains the neural networks on data generated while the neural networks are controlling a computer simulation of the facility 110. That is, the system 190 trains the neural networks in simulation, e.g., by causing the neural networks to control a simulated facility generated by a computer simulator, and then deploys the neural network for controlling the facility 110. In yet other implementations, the system 190 trains the neural networks in simulation and then fine-tunes, i.e., further trains, the neural networks while the neural networks are being used to control the facility 110. The computer simulation can be any appropriate simulation that accurately models the impact of control decisions on the state of the facility. One such simulator is described in Yuri Chervonyi, Praneet Dutta, Piotr Trochim, Octavian Voicu, Cosmin Paduraru, Crystal Qian, Emre Karagozler, Jared Quincy Davis, Richard Chippendale, Gautam Bajaj, et al. Semi-analytical industrial cooling system model for reinforcement learning. arXiv preprint arXiv: 2207.13131, 2022

Generally, the system 190 trains the high-level controller neural network 130 through reinforcement learning on high-level rewards that measure the performance of the high-level decisions in controlling the facility 110 and trains the low-level controller neural network 140 through reinforcement learning on low-level rewards that measure the performance of the low-level decisions in controlling the facility 110.

The high-level reward may measure how effectively the facility 110 is being controlled based on one or more metrics (factors) for the facility 110 (e.g. power consumption) that are affected by the high-level output generated by the high-level controller neural network 130.

Similarly, the low-level reward may measure how effectively the facility 110 is being controlled based on one or more metrics (factors) for the facility 110 (e.g. temperature of the facility) that are affected by the low-level output generated by the low-level controller neural network 140.

The metrics(s) on which the low-level reward is based may be the same as or different from the metrics(s) on which the high-level reward is based. In some implementations, the high-level reward is based on a metric that (typically) varies more slowly (i.e. over longer time scales) than a metric on which the low-level reward is based.

Examples of high- and low-level rewards are described in more detail below.

In some implementations, the system 190 trains the two neural networks jointly, i.e., on the same data and at the same time. In some other implementations, the system 190 pre-trains the low-level controller neural network 140, e.g., while the high-level decisions are made by a default high-level policy or a random policy, and then trains the high-level controller neural network 130 while holding the low-level controller neural network 140 fixed.

Training the neural networks is described below with reference to FIG. 2.

FIG. 2 is a flow diagram of an example process 200 for controlling a facility. For convenience, the process 200 will be described as being performed by a system of one or more computers located in one or more locations. For example, a facility control system, e.g., the facility control system 100 of FIG. 1, appropriately programmed in accordance with this specification, can perform the process 200.

In particular, in the example of FIG. 2, the facility includes a chiller plant that has multiple chillers and the system controls the chillers within the chiller plant.

The system can perform the process 200 at some or all of the time steps during a sequence of time steps, e.g., at some or all of the time steps while controlling the facility. The system continues performing the process 200 until one or more termination criteria are satisfied, e.g., indefinitely, until the facility reaches a designated termination state, or until a maximum number of time steps have elapsed.

In particular, in some implementations the system performs the process 200 at each time step. In some other implementations, when there is a maximum number of chillers that can be enabled at any given time, the system can use only the low-level controller neural network at some time steps in the sequence as will be described in more detail below.

The system receives an observation characterizing a state of the facility at the time step (step 202). For example, the observation characterizing the state of the facility can include a set of chiller plant measurements as of the current time step.

The chiller plant measurements can include any of a variety of measurements that characterize the state of the chiller plant, the facility or both.

As one example, the chiller plant measurements can specify the number of chillers that are enabled after the preceding time step.

As another example, the chiller plant measurements can specify the facility temperature as of the current time step.

As yet another example, the chiller plant measurements can specify the chiller plant power consumption of the chiller plant, e.g., the amount of power that has been consumed by the chiller plant in a most-recent time window leading up to the current time step.

The system identifies a current operational state of each chiller after the preceding time step (step 204). The operational state of a given chiller after the preceding time step indicates whether the chiller was enabled or disabled after the preceding time step.

The system processes a high-level input that includes the observation using a high-level controller neural network to generate a high-level output that specifies, for each chiller, whether to change the current operational state of the chiller (step 206).

That is, for each chiller that was enabled, the high-level output indicates whether to disable the chiller or keep the chiller enabled. For each chiller that was disabled, the high-level output indicates whether to enable the chiller or keep the chiller disabled.

Optionally, the high-level input can also include additional information in addition to the observation. For example, the high-level input can optionally include the high-level reward that was received at the preceding time step.

In some implementations, the high-level output also specifies, for each chiller that will be enabled as a result of changing the current operational state of the chiller, a step goal defining a number of consecutive time steps for which the chiller will remain enabled. That is, the high-level output indicates not only whether to enable a given chiller but also indicates, if the chiller is enabled, how many time steps, starting from the current time step, the given chiller will remain enabled for.

The system determines, based on the current operational states of the chillers and the high-level output, a new operational state of each chiller that indicates whether the chiller will be enabled or disabled at the time step (step 208).

For example, for each chiller that was disabled after the preceding time step, the system can determine to enable the chiller only if the high-level output specifies that the operational state of the chiller should be changed.

As another example, when the high-level output does not include the step goal, for each chiller that was enabled after the preceding time step, the system can determine to disable the chiller only if the high-level output specifies that the operational state of the chiller should be changed.

As yet another example, when the high-level output does include the step goal, for each chiller that was enabled after the preceding time step, the system can determine whether the step goal for the chiller that was specified by the high-level output generated at a preceding time step at which the chiller was enabled, i.e., the step goal specified at the most recent time step at which the operational state of the chiller was changed to enable the chiller, has been satisfied. That is, the system can determine if the number of time steps specified by the step goal has elapsed since the preceding time step at which the chiller was enabled.

The system can then determine to disable the chiller only if both (i) the step goal has been satisfied and (ii) the high-level output specifies that the operational state of the chiller be changed.

In some implementations, there may be a maximum number of chillers that can be enabled at any given time, e.g., as specified by the control system of the facility or chiller plant.

In these implementations, prior to performing step 206, i.e., prior to processing any inputs using the high-level controller neural network, the system can determine whether the maximum number of chillers are enabled at the beginning of the current time step. If the maximum number of chillers are enabled at the beginning of the current time step and the step goal has not been satisfied for any of the enabled chillers, the system can refrain from performing step 206, i.e., refrain from processing any inputs using the high-level controller because the operational states of the chillers cannot change, i.e., no new chillers can be enabled because the maximum has been reached and no chillers can be disabled because no step goals have been satisfied. In the cases, the system can set the new operational states to be the same as the current operational states for all of the chillers.

The system processes a low-level input that includes the observation using a low-level controller neural network to generate a low-level output that specifies, for each chiller having a new operational state that indicates that the chiller will be enabled at the time step, a temperature set point for the chiller (step 210).

Optionally, the low-level input can include additional information in addition to the observation. For example, the low-level input can include (i) data indicating the new operational states for one or more of the chillers, e.g., for all of the chillers or only for chillers whose operational states have changed, (ii) for each chiller that will be enabled as a result of changing the current operational state of the chiller, data identifying the step goal for the chiller, or (iii) both. The low-level input can also optionally include, for each chiller that was already enabled and did not have its operational state changed, the number of time steps left in the step goal for the chiller. As another example, the low-level input can include the low-level reward from the preceding time step.

The system can then transmit data to a control system for the facility, e.g., a hardware controller, that causes the plurality of chillers to operate in accordance with the new operational states and temperature set points or otherwise control the chillers to operate in accordance with the new operational states and temperature set points, e.g., as described above with reference to FIG. 1.

In some implementations, the system performs the process 200 to control the facility during the training of the low-level controller neural network, the high-level controller neural network, or both through reinforcement learning.

When the system is performing the process 200 during the training of the high-level controller neural network, the system receives a high-level reward for the time step and trains the high-level neural network through reinforcement learning using the observation, the high-level output, and the high-level reward. For example, the system can store a transition that includes the observation, the high-level output, and the high-level reward in a replay memory and periodically sample a set of transitions from the replay memory to train the high-level controller neural network, e.g., using an off-policy reinforcement learning technique, e.g., a policy-optimization technique, e.g., one based on Maximum A-Posteriori Policy Optimization (MPO).

When the system is performing the process 200 during the training of the low-level controller neural network, the system receives a low-level reward for the time step and trains the low-level neural network through reinforcement learning using the observation, the low-level output, and the low-level reward. For example, the system can store a transition that includes the observation (or, more generally, the low-level input), the low-level output, and the low-level reward in a replay memory and periodically sample a set of transitions from the replay memory to train the low-level controller neural network, e.g., using an off-policy reinforcement learning technique, e.g., a policy-optimization technique, e.g., one based on Maximum A-Posteriori Policy Optimization (MPO).

The high-level reward can be based on any of a variety of factors that are impacted by the high-level decisions made by the high-level controller neural network.

For example, the high-level reward can based at least in part on power consumed by the chiller plant at the time step. That is, the high-level reward can be lower when the power consumption is greater in order to encourage power usage to be minimized. As a particular example, the high-level reward for a time step t can include a term p(t) that is based on the power usage and that satisfies:

$$p ( t ) = {( \frac{w ( t )}{1000} + 1 )}^{- 1} ,$$

where w(t) is the amount of power used at the time step t in an appropriate unit of measurement, e.g., watts, kilowatts, and so on. Other terms p(t) that is based on the power usage are also possible.

As another example, the high-level reward can based at least in part on respective durations of times that each of the plurality of chillers have been enabled over at least some of the preceding time steps. For example, the high-level reward can be based at least in part on, for each chiller, a respective fraction of time in a specified time window for which the chiller has been enabled. This term can encourage the usage across chillers to be balanced to avoid excessive wear and tear on any one chiller. As a particular example, the high-level reward for a time step t can include a term h(t) that satisfies:

$$h ( t ) = \frac{1}{log {n}_{t o t}} {\sum }_{i = 1}^{{n}_{t o t}} - {p}_{i} log {p}_{i} ,$$

where nₜₒₜ is the total number of chillers,

$${p}_{i} = \frac{chiller i on time}{{\sum }_{j \neq i} chiller j on time} ,$$

and where “chiller i on time” measures the respective duration of time in the specified time window for which the chiller has been enabled. Other terms h(t) that are based on the time enabled are also possible.

As another example, the high-level reward can be based at least in part on a penalty term that is only non-zero when a number of chillers enabled at the time step does not match a target number of enabled chillers. That is, this term can prevent the high-level controller from optimizing the high-level reward by simply turning all of the chillers on or off at all time steps. As a particular example, the high-level reward for a time step/can include a term Π(nₑ≠n_{d}), where I is the indicator function, nₑ is the number of enabled chillers, and n_{d} is the target number of enabled chillers.

High-level rewards based on factors other than the number of enabled chillers may additionally or alternatively be used for this purpose.

As a particular example, the overall high-level reward R_{HLA}(t) may satisfy:

$${R}_{HLA} ( t ) = {α}_{h} \cdot {h ( t )}^{{λ}_{h}} - {α}_{o} \cdot 𝕀 ( {n}_{e} \neq {n}_{d} ) + {α}_{p} \cdot {p ( t )}^{{λ}_{p}} ,$$

where αₕ, λₕ, αₒ, αₚ, and λₚ are hyperparameters.

The low-level reward can be based on any of a variety of factors that are impacted by the low-level decisions made by the low-level controller neural network.

For example, the low-level reward can be based in part on power consumed by the chiller plant at the time step. That is, like the high-level reward, the low-level reward can be lower when the power consumption is greater in order to encourage power usage to be minimized. As a particular example, the low-level reward for a time step/can include the term p(t) described above or a different p(t) term that is based on the power usage.

As another example, the low-level reward can be based on a temperature of the facility at the time step. For example, the low-level reward can based on whether the temperature of the facility at the time step violates any constraints on facility temperature. That is, this term can be smaller when constraints are violated than when no constraints are violated. As a particular example, the low-level reward for a time step/can include a term c(t) that satisfies:

$$c ( t ) = max ( {v}_{upper} ( t ) , {v}_{lower} ( t ) ) ,$$

where vᵤₚₚₑᵣ(t) is the amount by which the dry bulb temperature at time step/violates a temperature upper bound (with a minimum value of zero) and v_{lower}(t) is the amount by which the dry bulb temperature at time step/violates a temperature lower bound (with a minimum value of zero).

As a particular example, the overall low-level reward R_{LLA}(t) may satisfy:

$${R}_{LLA} ( t ) = {α}_{p} \cdot {p ( t )}^{{λ}_{p}} + {α}_{c} \cdot {c ( t )}^{{λ}_{c}}$$

where α_{c}, λ_{c}, αₒ, αₚ, and λₚ are hyperparameters.

FIG. 3 shows an example 300 of the operation of the system in controlling a chiller plant at a given time step.

As shown in FIG. 3, the system receives an environment observation 302 at the time step characterizing the state of the facility. For example, the observation characterizing the state of the facility can include a set of chiller plant measurements as of the current time step as described above.

The system processes a high-level input that includes the observation 302 using the high-level controller neural network (“high-level agent”) 130 to generate a high-level output 304 that specifies, for each chiller, whether to change the current operational state of the chiller (“chiller on/off”) and, for each chiller that is to be enabled, a step goal.

The system processes a low-level input that includes the observation 302 using the low-level controller neural network 140 to generate a low-level output 306 that specifies, for each chiller having a new operational state that indicates that the chiller will be enabled at the time step, a temperature set point for the chiller.

In the example of FIG. 3, the low-level input also include (i) data indicating the new operational states for one or more of the chillers and (ii) for each chiller that will be enabled as a result of changing the current operational state of the chiller, data identifying the step goal for the chiller. The low-level input can also optionally include, for each chiller that was already enabled and did not have its operational state changed, the number of time steps left in the step goal for the chiller.

The system can then transmit output data 308 (e.g. over a wired or wireless network) to a control system for the facility that, based on the output data 308, causes the plurality of chillers to operate in accordance with the new operational states and temperature set points or otherwise controls the chillers to operate in accordance with the new operational states and temperature set points.

As described above, in some implementations, there is a maximum number of chillers that can be enabled at any given time, e.g., as specified by the control system of the facility or chiller plant. In these implementations, and as shown in FIG. 3, at some time steps the system does not make use of the high-level controller neural network 130 (such cases may be considered as the low-level controller neural network 140 being used for one or more sub-steps of a time step, where the high-level controller neural network 130 is not used for the sub-step(s)).

In particular, once the maximum number of chillers are enabled at the beginning of any given time step, the system can proceed to only use the low-level controller neural network 140 to update temperature set points for the enabled chillers at each time step until the step goal 312 for one of the enabled chillers is satisfied. That is, for each time step until the step goal for any of the enabled chillers is satisfied, the system refrains from processing any inputs using the high-level controller because the operational states of the chillers cannot change, i.e., no new chillers can be enabled because the maximum has been reached and no chillers can be disabled because no step goals have been satisfied.

While the above description describes controlling chillers using a hierarchical scheme, i.e., using a high-level controller neural network and a low-level controller neural network, as indicated above, the described techniques can generally be used to control other aspects of other equipment in a variety of types of industrial facilities.

For example, more generally, the high-level controller neural network can be used to determine whether to change the operational state of each of one or more items of equipment within the industrial facility (as described above for the chillers) and the low-level controller neural network can be used to set a value of an operating property for each item of equipment that is to be enabled (as described above for the chillers) according to the new operational states.

As a particular example, the high-level controller neural network can be used to determine whether to change the operational state of each of one or more boilers within an industrial boiler facility (as described above for the chillers) and the low-level controller neural network can be used to set a value of an operating property for each boiler that is to be enabled (as described above for the chillers) according to the new operational states. Examples of operating properties include temperature set points or settings for one or more secondary circuits associated with each of the boilers.

As another example, the described techniques can be used to control the temperature of a manufacturing process within a manufacturing facility. For example, the described techniques can be used to control an apparatus that has an internal liquid tank, which has a temperature that can be adjusted via one or more heating devices, and an external liquid tank whose temperature needs to be controlled. In these examples, the low-level controller can control the temperature in the internal tank and the high-level controller can provide a target temperature for the internal tank in order to heat the external liquid appropriately.

Some additional examples of industrial facilities (“environments”) that can be controlled by the hierarchical approach described in this application now follow.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

Clause 1. A method performed by one or more computers and for controlling a chiller plant comprising a plurality of chillers within a facility, the method comprising:
at each time step in a sequence of time steps:
   receiving an observation characterizing a state of the facility at the time step;
   identifying a current operational state of each chiller after a preceding time step in the sequence that indicates whether the chiller was enabled or disabled after the preceding time step;
   processing a high-level input comprising the observation using a high-level controller neural network to generate a high-level output that specifies, for each chiller, whether to change the current operational state of the chiller;
   determining, based on the current operational states of the chillers and the high-level output, a new operational state of each chiller that indicates whether the chiller will be enabled or disabled at the time step; and
   processing a low-level input comprising the observation using a low-level controller neural network to generate a low-level output that specifies, for each chiller having a new operational state that indicates that the chiller will be enabled at the time step, a temperature set point for the chiller.

Clause 2. The method of clause 1, further comprising:
transmitting data to a control system for the facility that causes the plurality of chillers to operate in accordance with the new operational states and temperature set points.

Clause 3. The method of clause 1 or clause 2, wherein determining, based on the current operational state and the high-level output, a new operational state of each chiller that indicates whether the chiller will be enabled or disabled at the time step comprises:
for each chiller that was disabled after the preceding time step, determining to enable the chiller only if the high-level output specifies that the operational state of the chiller be changed.

Clause 4. The method of clause 1, 2, or 3, wherein the high-level output further specifies, for each chiller that will be enabled as a result of changing the current operational state of the chiller, a step goal defining a number of consecutive time steps for which the chiller will remain enabled.

Clause 5. The method of clause 4, wherein determining, based on the current operational state and the high-level output, a new operational state of each chiller that indicates whether the chiller will be enabled or disabled at the time step comprises:
for each chiller that was enabled after the preceding time step:
   determining whether a step goal for the chiller that was specified by a high-level output generated at a preceding time step at which the chiller was enabled has been satisfied; and
   determining to enable the chiller only if the step goal has been satisfied and the high-level output specifies that the operational state of the chiller be changed.

Clause 6. The method of clause 4 or 5, wherein the low-level input comprises the observation and one or more of:
(i) data indicating the new operational states for one or more of the chillers, or
(ii) for each chiller that will be enabled as a result of changing the current operational state of the chiller, data identifying the step goal for the chiller.

Clause 7. The method of any preceding clause, wherein the observation comprises chiller plant measurements that comprise one or more of: a number of chillers enabled after the preceding time step, facility temperature, and chiller plant power consumption.

Clause 8. The method of any preceding clause, further comprising:
receiving a high-level reward for the time step; and
training the high-level neural network through reinforcement learning using the observation, the high-level output, and the high-level reward.

Clause 9. The method of clause 7, wherein the high-level reward is based at least in part on power consumed by the chiller plant at the time step.

Clause 10. The method of clause 8 or clause 9, wherein the high-level reward is based at least in part on respective durations of times that each of the plurality of chillers have been enabled.

Clause 11. The method of clause 10, wherein the high-level reward is based at least in part on, for each chiller, a respective fraction of time in a specified time window for which the chiller has been enabled.

Clause 12. The method of any one of clauses 9-11, wherein the high-level reward is based at least in part on a penalty term that is only non-zero when a number of chillers enabled at the time step does not match a target number of enabled chillers.

Clause 13. The method of any preceding clause, further comprising:
receiving a low-level reward for the time step; and training the low-level neural network through reinforcement learning using the observation, the low-level output, and the low-level reward.

Clause 14. The method of clause 13, wherein the low-level reward is based in part on power consumed by the chiller plant at the time step.

Clause 15. The method of clause 13 or clause 14, wherein the low-level reward is based on a temperature of the facility at the time step.

Clause 16. The method of clause 15, wherein the low-level reward is based on whether the temperature of the facility at the time step violates any constraints on facility temperature.

Clause 17. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-16.

Clause 18. One or more non-transitory computer storage media storing instructions that when executed by one or more computers cause the one or more computers to perform the operations of the respective method of any one of clauses 1-16.

What is claimed is:

1. A method performed by one or more computers and for controlling a plurality of items of equipment within a facility, the method comprising:
at each time step in a sequence of time steps:
receiving an observation characterizing a state of the facility at the time step;
identifying a current operational state of each item of equipment after a preceding time step in the sequence that indicates whether the item of equipment was enabled or disabled after the preceding time step;
processing a high-level input comprising the observation using a high-level controller neural network to generate a high-level output that specifies, for each item of equipment, whether to change the current operational state of the item of equipment;
determining, based on the current operational states of the items of equipment and the high-level output, a new operational state of each item of equipment that indicates whether the item of equipment will be enabled or disabled at the time step; and
processing a low-level input comprising the observation using a low-level controller neural network to generate a low-level output that specifies, for each item of equipment having a new operational state that indicates that the item of equipment will be enabled at the time step, a value of an operating property for the item of equipment.

2. The method of claim 1, wherein:
the facility is an industrial boiler facility and the items of equipment are boilers; or
the facility has a chiller plant and the items of equipment are a plurality of chillers within the chiller plant.

3. The method of claim 1, wherein:
the facility has a chiller plant, the items of equipment are a plurality of chillers within the chiller plant, and
the low-level output specifies, for each chiller having a new operational state that indicates that the chiller will be enabled at the time step, a temperature set point for the chiller.

4. The method of claim 3, further comprising:
transmitting data to a control system for the facility that causes the plurality of chillers to operate in accordance with the new operational states and temperature set points.

5. The method of claim 3, wherein determining, based on the current operational state and the high-level output, a new operational state of each chiller that indicates whether the chiller will be enabled or disabled at the time step comprises:
for each chiller that was disabled after the preceding time step, determining to enable the chiller only if the high-level output specifies that the operational state of the chiller be changed.

6. The method of claim 3, wherein the high-level output further specifies, for each chiller that will be enabled as a result of changing the current operational state of the chiller, a step goal defining a number of consecutive time steps for which the chiller will remain enabled.

7. The method of claim 6, wherein determining, based on the current operational state and the high-level output, a new operational state of each chiller that indicates whether the chiller will be enabled or disabled at the time step comprises:
for each chiller that was enabled after the preceding time step:
determining whether a step goal for the chiller that was specified by a high-level output generated at a preceding time step at which the chiller was enabled has been satisfied; and
determining to enable the chiller only if the step goal has been satisfied and the high-level output specifies that the operational state of the chiller be changed.

8. The method of claim 6, wherein the low-level input comprises the observation and one or more of:
(i) data indicating the new operational states for one or more of the chillers, or
(ii) for each chiller that will be enabled as a result of changing the current operational state of the chiller, data identifying the step goal for the chiller.

9. The method of claim 3, wherein the observation comprises chiller plant measurements that comprise one or more of: a number of chillers enabled after the preceding time step, facility temperature, and chiller plant power consumption.

10. The method of claim 1, further comprising:
receiving a high-level reward for the time step; and
training the high-level neural network through reinforcement learning using the observation, the high-level output, and the high-level reward.

11. The method of claim 10, wherein;
the facility has a chiller plant, the items of equipment are a plurality of chillers within the chiller plant,
the low-level output specifies, for each chiller having a new operational state that indicates that the chiller will be enabled at the time step, a temperature set point for the chiller, and
the high-level reward is based at least in part on power consumed by the chiller plant at the time step.

12. The method of claim 11, wherein the high-level reward is based at least in part on respective durations of times that each of the plurality of chillers have been enabled.

13. The method of claim 12, wherein the high-level reward is based at least in part on, for each chiller, a respective fraction of time in a specified time window for which the chiller has been enabled.

14. The method of claim 11, wherein the high-level reward is based at least in part on a penalty term that is only non-zero when a number of chillers enabled at the time step does not match a target number of enabled chillers.

15. The method of claim 1, further comprising:
receiving a low-level reward for the time step; and
training the low-level neural network through reinforcement learning using the observation, the low-level output, and the low-level reward.

16. The method of claim 15, wherein:
the facility has a chiller plant, the items of equipment are a plurality of chillers within the chiller plant,
the low-level output specifies, for each chiller having a new operational state that indicates that the chiller will be enabled at the time step, a temperature set point for the chiller, and
the low-level reward is based in part on power consumed by the chiller plant at the time step.

17. The method of claim 15, wherein the low-level reward is based on a temperature of the facility at the time step.

18. The method of claim 17, wherein the low-level reward is based on whether the temperature of the facility at the time step violates any constraints on facility temperature.

19. A system comprising:
one or more computers; and
one or more storage devices communicatively coupled to the one or more computers, wherein the one or more storage devices store instructions that, when executed by the one or more computers, cause the one or more computers to perform operations for controlling a plurality of items of equipment within a facility, the operations comprising:
at each time step in a sequence of time steps:
receiving an observation characterizing a state of the facility at the time step;
identifying a current operational state of each item of equipment after a preceding time step in the sequence that indicates whether the item of equipment was enabled or disabled after the preceding time step;
processing a high-level input comprising the observation using a high-level controller neural network to generate a high-level output that specifies, for each item of equipment, whether to change the current operational state of the item of equipment;
determining, based on the current operational states of the items of equipment and the high-level output, a new operational state of each item of equipment that indicates whether the item of equipment will be enabled or disabled at the time step; and
processing a low-level input comprising the observation using a low-level controller neural network to generate a low-level output that specifies, for each item of equipment having a new operational state that indicates that the item of equipment will be enabled at the time step, a value of an operating property for the item of equipment.

20. One or more non-transitory computer-readable storage media storing instructions that, when executed by one or more computers, cause the one or more computers to perform operations for controlling a plurality of items of equipment within a facility, the operations comprising:
at each time step in a sequence of time steps:
receiving an observation characterizing a state of the facility at the time step;
identifying a current operational state of each item of equipment after a preceding time step in the sequence that indicates whether the item of equipment was enabled or disabled after the preceding time step;
processing a high-level input comprising the observation using a high-level controller neural network to generate a high-level output that specifies, for each item of equipment, whether to change the current operational state of the item of equipment;
determining, based on the current operational states of the items of equipment and the high-level output, a new operational state of each item of equipment that indicates whether the item of equipment will be enabled or disabled at the time step; and
processing a low-level input comprising the observation using a low-level controller neural network to generate a low-level output that specifies, for each item of equipment having a new operational state that indicates that the item of equipment will be enabled at the time step, a value of an operating property for the item of equipment.
